(19) United States
(12) Patent Application Publication
(10) Pub. No.: US 2021/0142095 A1
(43) Pub. Date: May 13, 2021

(54) IMAGE DISPARITY ESTIMATION

(71) Applicant: Beijing Sensetime Technology Development Co., Ltd., Beijing (CN)

(72) Inventor: Jianping SHI, Beijing (CN)

(21) Appl. No.: 17/152,897

(22) Filed: Jan. 20, 2021

Related U.S. Application Data
(63) Continuation of application No. PCT/CN2019/097307, filed on Jul. 23, 2019.

(30) Foreign Application Priority Data
Jul. 25, 2018 (CN) 201810824486.9

(51) Int. Cl. G06K 9/46; G06N 3/04; G06K 9/62; G06T 7/11

(52) U.S. Cl. CPC G06K 9/4604; G06T 7/11; G06K 9/6259; G06N 3/04

(57) ABSTRACT

The present application discloses image disparity estimation methods and apparatuses, and non-transitory computer-readable storage media. The method includes: obtaining a first view image and a second view image of a target scene; performing feature extraction processing on the first view image to obtain first view feature information; performing semantic segmentation processing on the first view image to obtain first view semantic segmentation information; and obtaining disparity prediction information between the first view image and the second view image based on the first view feature information, the first view semantic segmentation information, and correlation information between the first view image and the second view image.

### CROSS-REFERENCE OF RELATED APPLICATIONS

This application is a continuation of International Patent Application No. PCT/CN2019/097307, filed on Jul. 23, 2019, which is based on and claims priority to and benefits of Chinese Patent Application No. 201810824486.9, filed on Jul. 25, 2018. The content of all of the above applications is incorporated herein by reference in their entirety.

### TECHNICAL FIELD

This application relates to the field of computer vision technology, and in particular, to an image disparity estimation method and apparatus, and a storage medium.

### BACKGROUND

Disparity estimation is a fundamental research problem in computer vision, and has deep applications in many fields, such as depth prediction, scene understanding, and so on. In most methods, a task of the disparity estimation is regarded as a matching problem. From this perspective, these methods use stable and reliable features to represent image patches, and select approximate image patches from stereo images as a matching pair, and then calculate disparity values.

### SUMMARY

The present application provides technical solutions for image disparity estimation.

In a first aspect, examples of the present application provide an image disparity estimation method. The method includes: obtaining a first view image and a second view image of a target scene; performing feature extraction processing on the first view image to obtain first view feature information; performing semantic segmentation processing on the first view image to obtain first view semantic segmentation information; and obtaining disparity prediction information between the first view image and the second view image based on the first view feature information, the first view semantic segmentation information, and correlation information between the first view image and the second view image.

In the above solution, optionally, the method further includes: performing the feature extraction processing on the second view image to obtain second view feature information; and performing correlation processing based on the first view feature information and the second view feature information to obtain the correlation information.

In the above solutions, optionally, obtaining the disparity prediction information between the first view image and the second view image based on the first view feature information, the first view semantic segmentation information, and the correlation information between the first view image and the second view image includes: performing hybrid processing on the first view feature information, the first view semantic segmentation information, and the correlation information to obtain hybrid feature information; and obtaining the disparity prediction information based on the hybrid feature information.

In the above solutions, optionally, the image disparity estimation method is implemented by a disparity estimation neural network, and the method further includes: training the disparity estimation neural network based on the disparity prediction information.

In the above solutions, optionally, training the disparity estimation neural network based on the disparity prediction information includes: performing the semantic segmentation processing on the second view image to obtain second view semantic segmentation information; obtaining first view reconstruction semantic information based on the second view semantic segmentation information and the disparity prediction information; and adjusting network parameters of the disparity estimation neural network based on the first view reconstruction semantic information.

In the above solutions, optionally, adjusting the network parameters of the disparity estimation neural network based on the first view reconstruction semantic information includes: determining a semantic loss value based on the first view reconstruction semantic information; and adjusting the network parameters of the disparity estimation neural network based on the semantic loss value.

In the above solutions, optionally, adjusting the network parameters of the disparity estimation neural network based on the first view reconstruction semantic information includes: adjusting the network parameters of the disparity estimation neural network based on the first view reconstruction semantic information and a first semantic label of the first view image; or adjusting the network parameters of the disparity estimation neural network based on the first view reconstruction semantic information and the first view semantic segmentation information.

In the above solutions, optionally, training the disparity estimation neural network based on the disparity prediction information includes: obtaining a first view reconstruction image based on the disparity prediction information and the second view image; determining a photometric loss value based on a photometric difference between the first view reconstruction image and the first view image; determining a smoothness loss value based on the disparity prediction information; and adjusting the network parameters of the disparity estimation neural network based on the photometric loss value and the smoothness loss value.

In the above solutions, optionally, the first view image and the second view image correspond to labelled disparity information, and the method further includes: training a disparity estimation neural network for implementing the method based on the disparity prediction information and the labelled disparity information.

In the above solutions, optionally, training the disparity estimation neural network based on the disparity prediction information and the labelled disparity information includes: determining a disparity regression loss value based on the disparity prediction information and the labelled disparity information; and adjusting network parameters of the disparity estimation neural network based on the disparity regression loss value.

In a second aspect, examples of the present application provide an image disparity estimation apparatus. The apparatus includes: an image obtaining module configured to obtain a first view image and a second view image of a target scene; and a disparity estimation neural network configured to obtain disparity prediction information based on the first view image and the second view image, and including: a primary feature extraction module configured to perform feature extraction processing on the first view image to obtain first view feature information; a semantic feature extraction module configured to perform semantic segmentation processing on the first view image to obtain first view semantic segmentation information; and a disparity regression module configured to obtain the disparity prediction information between the first view image and the second view image based on the first view feature information, the first view semantic segmentation information, and correlation information between the first view image and the second view image.

In the above solution, optionally, the primary feature extraction module is further configured to perform the feature extraction processing on the second view image to obtain second view feature information; and the disparity regression module further includes: a correlation feature extraction module configured to perform correlation processing based on the first view feature information and the second view feature information to obtain the correlation information.

In the above solutions, optionally, the disparity regression module is further configured to: perform hybrid processing on the first view feature information, the first view semantic segmentation information, and the correlation information to obtain hybrid feature information; and obtain the disparity prediction information based on the hybrid feature information.

In the above solutions, optionally, the apparatus further includes: a first network training module configured to train the disparity estimation neural network based on the disparity prediction information.

In the above solutions, optionally, the first network training module is further configured to: perform the semantic segmentation processing on the second view image to obtain second view semantic segmentation information; obtain first view reconstruction semantic information based on the second view semantic segmentation information and the disparity prediction information; and adjust network parameters of the disparity estimation neural network based on the first view reconstruction semantic information.

In the above solutions, optionally, the first network training module is further configured to: determine a semantic loss value based on the first view reconstruction semantic information; and adjust the network parameters of the disparity estimation neural network based on the semantic loss value.

In the above solutions, optionally, the first network training module is further configured to: adjust the network parameters of the disparity estimation neural network based on the first view reconstruction semantic information and a first semantic label of the first view image; or adjust the network parameters of the disparity estimation neural network based on the first view reconstruction semantic information and the first view semantic segmentation information.

In the above solutions, optionally, the first network training module is further configured to: obtain a first view reconstruction image based on the disparity prediction information and the second view image; determine a photometric loss value based on a photometric difference between the first view reconstruction image and the first view image; determine a smoothness loss value based on the disparity prediction information; and adjust the network parameters of the disparity estimation neural network based on the photometric loss value and the smoothness loss value.

In the above solutions, optionally, the apparatus further includes: a second network training module configured to train the disparity estimation neural network based on the disparity prediction information and labelled disparity information, wherein the first view image and the second view image correspond to the labelled disparity information.

In the above solutions, optionally, the second network training module is further configured to: determine a disparity regression loss value based on the disparity prediction information and the labelled disparity information; and adjust network parameters of the disparity estimation neural network based on the disparity regression loss value.

In a third aspect, examples of the present application provide an image disparity estimation apparatus. The apparatus includes: a memory, a processor and a computer-readable program stored in the memory and executable by the processor, when the computer-readable program is executed by the processor, the processor implements steps of the image disparity estimation method described in the examples of the present application.

In a fourth aspect, examples of the present application provide a non-transitory storage medium storing a computer-readable program that, when the computer-readable program is executed by a processor, causes the processor to perform steps of the image disparity estimation method described in the examples of the present application.

According to the technical solutions provided by the present application, the first view image and the second view image of the target scene are obtained, the feature extraction processing is performed on the first view image to obtain the first view feature information, the semantic segmentation processing is performed on the first view image to obtain the first view semantic segmentation information, and the disparity prediction information between the first view image and the second view image is obtained based on the first view feature information, the first view semantic segmentation information, and the correlation information between the first view image and the second view image, which can improve the accuracy of disparity prediction.

### BRIEF DESCRIPTION OF THE DRAWINGS

FIG. 1 is a schematic diagram illustrating an implementation process of an image disparity estimation method according to an example of the present application.

FIG. 2 is a schematic diagram illustrating an architecture of a disparity estimation system according to an example of the present application.

FIGS. 3A-3D are diagrams comparing effects of using an existing estimation method with an estimation method provided by an example of the present application on a KITTI Stereo dataset.

FIGS. 4A and 4B illustrate supervised qualitative results on KITTI Stereo test sets according to an example of the present application, where FIG. 4A illustrates KITTI 2012 test data qualitative results, and FIG. 4B illustrates KITTI 2015 test data qualitative results.

FIGS. 5A-5C illustrate an unsupervised qualitative result on a CityScapes verification set according to an example of the present application.

FIG. 6 is a schematic structural diagram illustrating an image disparity estimation apparatus according to an example of the present application.

### DETAILED DESCRIPTION OF THE EMBODIMENTS

To better explain the present application, some examples of disparity estimation methods are introduced below.

Disparity estimation is a fundamental problem in computer vision. It has a wide range of applications, including depth prediction, scene understanding and autonomous driving. The main process of disparity estimation is to find matching pixels from left and right images of a stereo image pair. The distance between the matching pixels is disparity. Many disparity estimation methods rely on designing reliable features to represent image patches, and then matching image patches are selected from the left and right images to calculate the disparity. A majority of the methods use a supervised learning approach to train a neural network to predict disparity, and a minority of the methods try to use an unsupervised learning approach to train a neural network.

Recently, with the development of deep neural networks, the performance of disparity estimation has been greatly improved. Thanks to better robustness of the deep neural networks in extracting image features, more accurate and reliable search and localization of matching image patches can be achieved.

However, although a specific local search range is given and a deep learning method itself has a large receptive field, it is still difficult to overcome the problem of local ambiguity, which mainly comes from a textureless area in an image. For example, disparity prediction on a road center, a vehicle center, a bright light area, and a shadow area is often incorrect, mainly because these areas lack sufficient texture information and a photometric consistency loss is not enough to guide a neural network seeking a correct matching position. Moreover, this problem is encountered during training neural networks in supervised or unsupervised learning approaches.

Based on this, the present application proposes a technical solution for image disparity estimation using semantic information.

Technical solutions of the present application will be further elaborated below with reference to the drawings and specific examples.

Examples of the present application provide an image disparity estimation method. As shown in FIG. 1, the method mainly includes the following steps.

At step 101, a first view image and a second view image of a target scene are obtained.

The first view image and the second view image are images of a same spatiotemporal scene collected by two video cameras or two photo cameras in a binocular vision system at the same time.

For example, the first view image may be an image collected by a first video camera in the binocular vision system, and the second view image may be an image collected by a second video camera in the binocular vision system.

The first view image and the second view image represent images collected at different viewpoints for the same scene. The first view image and the second view image may be a left view image and a right view image, respectively. Specifically, the first view image may be the left view image, and correspondingly, the second view image may be the right view image; or, the first view image may be the right view image, and correspondingly, the second view image may be the left view image. The specific implementations of the first view image and the second view image are not limited in the examples of the present application.

The scene includes an assistant driving scene, a robot tracking scene, a robot positioning scene, etc. The present application does not limit scenes.

At step 102, feature extraction processing is performed on the first view image to obtain first view feature information.

The step 102 may be implemented by using a convolutional neural network. For example, the first view image may be input into a disparity estimation neural network for processing, which may be named as SegStereo network hereinafter for ease of description.

The first view image may be used as an input of a first sub-network for performing the feature extraction processing in the disparity estimation neural network. Specifically, the first view image is input to the first sub-network, and the first view feature information is acquired after a multi-layer convolution operation or after further processing based on the convolution operation.

The first view feature information may be a first view primary feature map, or the first view feature information and second view feature information may be a three-dimensional tensor and include at least one matrix. The specific implementation of the first view feature information is not limited in the examples of the present disclosure.

A feature extraction network or a convolution sub-network in a disparity estimation neural network is used to extract the feature information or primary feature map of the first view image.

At step 103, semantic segmentation processing is performed on the first view image to obtain first view semantic segmentation information.

The SegStereo network includes at least two sub-networks, which are respectively labelled as a first sub-network and a second sub-network. The first sub-network may be a feature extraction network, and the second sub-network may be a semantic segmentation network. The feature extraction network may obtain a view primary feature map, and the semantic segmentation network may obtain a semantic feature map. Exemplarily, the first sub-network may be implemented using at least a part of PSPNet-50 (Pyramid Scene Parsing Network), and at least a part of the second sub-network may be implemented using the PSPNet-50. That is, the first sub-network and the second sub-network may share partial structure of the PSPNet-50. However, the specific implementation of the SegStereo network is not limited in the examples of the present application.

The first view image may be input into the semantic segmentation network for semantic segmentation processing to obtain the first view semantic segmentation information.

The first view feature information may also be input into the semantic segmentation network for the semantic segmentation processing to obtain the first view semantic segmentation information. Correspondingly, performing the semantic segmentation processing on the first view image to obtain the first view semantic segmentation information includes: obtaining the first view semantic segmentation information based on the first view feature information.

The first view semantic segmentation information may be a three-dimensional tensor or a first view semantic feature map. The specific implementations of the first view semantic segmentation information are not limited in the examples of the present disclosure.

The first view primary feature map may be used as an input of the second sub-network for semantic information extraction processing in the disparity estimation neural network. Specifically, the first view feature information or the first view primary feature map is input to the second sub-network, and the first view semantic segmentation information is obtained after a multi-layer convolution operation or after further processing based on the convolution operation.

At step 104, disparity prediction information between the first view image and the second view image is obtained based on the first view feature information, the first view semantic segmentation information, and correlation information between the first view image and the second view image.

Correlation processing may be performed on the first view image and the second view image to obtain the correlation information between the first view image and the second view image.

The correlation processing may also be performed based on the first view feature information and second view feature information to obtain the correlation information between the first view image and the second view image. The second view feature information is obtained by performing feature extraction processing on the second view image. The second view feature information may be a second view primary feature map, or the second view feature information may be a three-dimensional tensor and include at least one matrix. The specific implementations of the second view feature information are not limited in the examples of the present disclosure.

The second view image may be used as an input of the first sub-network for performing the feature extraction processing in the disparity estimation neural network. Specifically, the second view image is input to the first sub-network, and the second view feature information is acquired after a multi-layer convolution operation. Then, correlation calculation is performed based on the first view feature information and the second view feature information to obtain the correlation information between the first view image and the second view image.

Performing the correlation calculation based on the first view feature information and the second view feature information includes: performing correlation calculation on one or more possible matching image patches in both of the first view feature information and the second view feature information to obtain the correlation information. That is to say, the correlation calculation is performed on the first view feature information and the second view feature information to obtain the correlation information. The correlation information is mainly used for extraction of matching features. The correlation information may be a correlation feature map.

The first view primary feature map and the second view primary feature map may be used as inputs of a correlation calculation module for correlation calculation in the disparity estimation neural network. For example, the first view primary feature map and the second view primary feature map are input to a correlation calculation module 240 shown in FIG. 2, and the correlation information between the first view image and the second view image is obtained after the correlation calculation.

Obtaining the disparity prediction information between the first view image and the second view image based on the first view feature information, the first view semantic segmentation information, and the correlation information between the first view image and the second view image includes: performing hybrid processing on the first view feature information, the first view semantic segmentation information, and the correlation information to obtain hybrid feature information; and obtaining the disparity prediction information based on the hybrid feature information.

The hybrid processing may be concatenate processing, such as fusion or superimposition according to channels, which is not limited in the examples of the present disclosure.

Before the hybrid processing is performed on the first view feature information, the first view semantic segmentation information, and the correlation information, transformation processing may be performed on one or more of the first view feature information, the first view semantic segmentation information, and the correlation information, such that the first view feature information, the first view semantic segmentation information, and the correlation information after the transformation processing have the same size.

The method may further include: performing transformation processing on the first view feature information to obtain first view transformation feature information. In this way, hybrid processing may be performed on the first view transformation feature information, the first view semantic segmentation information, and the correlation information to obtain the hybrid feature information. For example, spatial transformation processing is performed on the first view feature information to obtain the first view transformation feature information, where a size of the first view transformation feature information is preset.

Optionally, the first view transformation feature information may be a first view transformation feature map, and the specific implementations of the first view transformation feature information are not limited in the examples of the present disclosure.

For example, the first view feature information output by the first sub-network is subjected to a convolution operation of a convolution layer to obtain the first view transformation feature information. A convolution module may be used to process the first view feature information to obtain the first view transformation feature information.

Optionally, the hybrid feature information may be a hybrid feature map. The specific implementations of the hybrid feature information are not limited in the examples of the present disclosure. The disparity prediction information may be a disparity prediction map, and the specific implementations of the disparity prediction information are not limited in the examples of the present disclosure.

In addition to the first sub-network and the second sub-network, the SegStereo network includes a third sub-network. The third sub-network is used to determine the disparity prediction information between the first view image and the second view image, and the third sub-network may be a disparity regression network.

Specifically, the first view transformation feature information, the correlation information, and the first view semantic segmentation information are input to the disparity regression network. The disparity regression network concatenates such information to hybrid feature information, and performs regression based on the hybrid feature information to obtain the disparity prediction information.

Based on the hybrid feature information, a residual network and deconvolution module 250 in the disparity regression network shown in FIG. 2 is used to predict the disparity prediction information.

That is to say, the first view transformation feature map, the correlation feature map, and the first view semantic feature map may be concatenated to obtain the hybrid feature map, thereby realizing semantic feature embedding. After the hybrid feature map is obtained, the residual network and a deconvolution structure in the disparity regression network are used to finally output a disparity prediction map.

The SegStereo network mainly employs a residual structure, which may extract more recognizable image features, and embeds a high-level semantic feature while extracting a correlation feature between the first view image and the second view image, thereby improving the accuracy of prediction.

The above method may be an application process of a disparity estimation neural network, that is, a method of using a trained disparity estimation neural network to perform disparity estimation on a to-be-processed image pair. In some examples, the above method may be a training process of a disparity estimation neural network, that is, the above method may be applicable to the training of a disparity estimation neural network. In this case, the first view image and the second view image are sample images.

In the examples of the present disclosure, a predefined neural network may be trained in an unsupervised approach to obtain a disparity estimation neural network including a first sub-network, a second sub-network, and a third sub-network. Alternatively, a disparity estimation neural network may be trained in a supervised approach to obtain a disparity estimation neural network including a first sub-network, a second sub-network and a third sub-network.

The method further includes: training the disparity estimation neural network based on the disparity prediction information.

Training the disparity estimation neural network based on the disparity prediction information includes: performing semantic segmentation processing on the second view image to obtain second view semantic segmentation information; obtaining first view reconstruction semantic information based on the second view semantic segmentation information and the disparity prediction information; and adjusting network parameters of the disparity estimation neural network based on the first view reconstruction semantic information. The first view reconstruction semantic information may be a reconstructed first semantic feature map.

Semantic segmentation processing may be performed on the second view image to obtain the second view semantic segmentation information.

The second view feature information may also be input into a semantic segmentation network for processing to obtain the second view semantic segmentation information. Correspondingly, performing the semantic segmentation processing on the second view image to obtain the second view semantic segmentation information includes: obtaining the second view semantic segmentation information based on the second view feature information.

The second view semantic segmentation information may be a three-dimensional tensor or a second view semantic feature map. The specific implementations of the second view semantic segmentation information are not limited in the examples of the present disclosure.

The second view primary feature map may be used as an input of a second sub-network for semantic information extraction processing in the disparity estimation neural network. Specifically, the second view feature information or the second view primary feature map is input to the second sub-network, and the second view semantic segmentation information is obtained after a multi-layer convolution operation or after further processing based on the convolution operation.

A semantic segmentation network or a convolution sub-network in the disparity estimation neural network can be used to extract the first view semantic feature map and the second view semantic feature map.

The first view feature information and the second view feature information may be input to the semantic segmentation network, and the semantic segmentation network outputs the first view semantic segmentation information and the second view semantic segmentation information.

Optionally, adjusting the network parameters of the disparity estimation neural network based on the first view reconstruction semantic information includes: determining a semantic loss value based on the first view reconstruction semantic information; and adjusting the network parameters of the disparity estimation neural network based on the semantic loss value.

Adjusting the network parameters of the disparity estimation neural network based on the first view reconstruction semantic information includes: adjusting the network parameters of the disparity estimation neural network based on the first view reconstruction semantic information and a first semantic label of the first view image; or adjusting the network parameters of the disparity estimation neural network based on the first view reconstruction semantic information and the first view semantic segmentation information.

Optionally, adjusting the network parameters of the disparity estimation neural network based on the first view reconstruction semantic information includes: determining a semantic loss value based on a difference between the first view reconstruction semantic information and the first view semantic segmentation information; and adjusting the network parameters of the disparity estimation neural network based on the semantic loss value.

Optionally, a reconstruction operation is performed based on the predicted disparity prediction information and the second view semantic segmentation information to obtain the first view reconstruction semantic information. The first view reconstruction semantic information may also be compared with a first semantic ground-truth label to obtain a semantic loss value; and the network parameters of the disparity estimation neural network are adjusted based on the semantic loss value. The first semantic ground-truth label is manually labelled, and the unsupervised learning approach here is an unsupervised learning approach for disparity other than for semantic segmentation information.

Semantic loss may be a cross-entropy loss, the specific implementations of the semantic loss are not limited in the examples of the present disclosure.

In training the disparity estimation neural network, a function for calculating the semantic loss is defined. Rich semantic consistency information may be introduced into the function, so that a trained neural network may decrease common local ambiguity problem.

Training the disparity estimation neural network based on the disparity prediction information includes: obtaining a first view reconstruction image based on the disparity prediction information and the second view image; determining a photometric loss value based on a photometric difference between the first view reconstruction image and the first view image; determining a smoothness loss value based on the disparity prediction information; and adjusting the network parameters of the disparity estimation neural network based on the photometric loss value and the smoothness loss value.

By imposing a constraint on an unsmooth area in the disparity prediction information, the smoothness loss may be determined.

A reconstruction operation is performed based on the predicted disparity prediction information and a true second view image to obtain the first view reconstruction image, and a photometric difference between the first view reconstruction image and a true first view image is compared to obtain the photometric loss.

By measuring a photometric difference of a reconstruction image, the network may be trained in an unsupervised approach, thereby greatly reducing the dependence on a ground-truth image.

Training the disparity estimation neural network based on the disparity prediction information further includes: performing a reconstruction operation based on the disparity prediction information and the second view image to obtain a first view reconstruction image; determining a photometric loss based on a photometric difference between the first view reconstruction image and the first view image; determining a smoothness loss by imposing a constraint on an unsmooth area in the disparity prediction information; determining a semantic loss based on a difference between the first view reconstruction semantic information and a first semantic ground-truth label; determining a total loss based on the photometric loss, the smoothness loss, and the semantic loss; and training the disparity estimation neural network based on minimizing the total loss. A training set used in the training does not need to provide a ground-truth disparity image.

The total loss is equal to a weighted sum of losses.

In this way, there is no need to provide the ground-truth disparity image. The neural network may be trained based on a photometric difference between a reconstruction image and an original image. When a correlation feature of a first view image and a second view image is extracted, a semantic feature map is embedded, and a semantic loss is defined. Combining low-level texture information and high-level semantic information, a semantic consistency constraint is added, which improves a disparity prediction level of the trained neural network in a large target area, and decreases the local ambiguity problem to a certain extent.

Optionally, the method of training the disparity estimation neural network further includes: training the disparity estimation neural network in a supervised approach based on the disparity prediction information.

Specifically, the first view image and the second view image correspond to labelled disparity information, and the disparity estimation neural network is trained based on the disparity prediction information and the labelled disparity information.

Optionally, training the disparity estimation neural network based on the disparity prediction information and the labelled disparity information includes: determining a disparity regression loss value based on the disparity prediction information and the labelled disparity information; determining a smoothness loss value based on the disparity prediction information; and adjusting the network parameters of the disparity estimation neural network based on the disparity regression loss value and the smoothness loss value.

Optionally, training the disparity estimation neural network based on the disparity prediction information and the labelled disparity information includes: determining a disparity regression loss based on the disparity prediction information and the labelled disparity information; determining a smoothness loss by imposing a constraint on an unsmooth area in the disparity prediction information; determining a semantic loss based on a difference between the first view reconstruction semantic information and a first semantic ground-truth label; determining a total loss for the training in a supervised approach based on the disparity regression loss, the semantic loss, and the smoothness loss; and training the disparity estimation neural network based on minimizing the total loss. A training set used in the training needs to provide the labelled disparity information.

Optionally, training the disparity estimation neural network based on the disparity prediction information and the labelled disparity information includes: determining a disparity regression loss based on the disparity prediction information and the labelled disparity information; determining a smoothness loss by imposing a constraint on an unsmooth area in the disparity prediction information; determining a semantic loss based on a difference between the first view reconstruction semantic information and the first view semantic segmentation information; determining a total loss for the training in a supervised approach based on the disparity regression loss, the semantic loss, and the smoothness loss; and training the disparity estimation neural network based on minimizing the total loss. A training set used in the training needs to provide the labelled disparity information.

In this way, the disparity estimation neural network may be trained in a supervised approach. For a position with a ground-truth signal, a difference between a predicted value and ground-truth is calculated as a supervised disparity regression loss. In addition, the semantic loss and smoothness loss used by unsupervised training are still employed.

The first sub-network, the second sub-network and the third sub-network are sub-networks obtained by training the disparity estimation neural network. For different sub-networks, that is, the first sub-network, the second sub-network and the third sub-network, input and output contents of the different sub-networks are different, but the sub-networks are aimed at the same target scene.

The method of training the disparity estimation neural network may include: using a training sample set to perform both disparity prediction map training and semantic feature map training on the disparity estimation neural network, so as to obtain optimized parameters of the first, second, and third sub-networks.

The method of training the disparity estimation neural network may include: firstly using a training sample set to perform semantic feature map training on the disparity estimation neural network; and then using the training sample set to perform disparity prediction map training on the disparity estimation neural network that is subjected to semantic feature map prediction training, so as to obtain optimized parameters of the second and first sub-networks.

That is to say, when the disparity estimation neural network is trained, the semantic feature map prediction training and the disparity prediction map training may be performed thereon in stages.

In the semantic information-based image disparity estimation methods provided by the examples of the present application, an end-to-end disparity prediction neural network is used, left and right view images of a stereo image pair are input to the neural network, and a disparity prediction map is directly obtained, which may meet real-time requirements. By measuring a photometric difference between a reconstruction image and an original image, the neural network may be trained in an unsupervised approach, which largely reduces the dependence on a ground-truth image. In addition, when extracting a correlation feature of the left and right view images, the semantic feature map is embedded, and the semantic loss is defined. Combining low-level texture information and high-level semantic information, a semantic consistency constraint is added, which improves a disparity prediction level of the neural network in a large target area, such as a large road surface, a big vehicle, etc., and decreases the local ambiguity problem to a certain extent.

FIG. 2 is a schematic diagram illustrating an architecture of a disparity estimation system. The architecture of the disparity estimation system is denoted as an architecture of a SegStereo disparity estimation system. The architecture of the SegStereo disparity estimation system is suitable for unsupervised and supervised learning.

Firstly, a basic network structure of the disparity estimation neural network is given. Then, how to introduce a semantic cue strategy in the disparity estimation neural network is elaborated. Finally, how to calculate loss items used during training the disparity estimation neural network in unsupervised and supervised approaches is shown.

The basic structure of the disparity estimation neural network is described firstly.

The schematic diagram illustrating the architecture of the entire system is shown in FIG. 2. A pre-calibrated stereo image pair may include a first view image (or called a left view image) I^{l} and a second view image (or called a right view image) I^{r}. A shallow neural network 210 may be used to extract a primary image feature map. The first view image I^{l} is input to the shallow neural network 210 to obtain a first view primary feature map F¹. The second view image I^{r} is input to the shallow neural network 210 to obtain a second view primary feature map F^{r}. The first view primary feature map may represent the aforementioned first view feature information, and the second view primary feature map may represent the aforementioned second view feature information. The shallow neural network 210 may be a convolution block of a kernel size 3×3×256, and the convolution block may include a convolution layer, and a batch normalization and Rectified Linear Unit (ReLU) layer. The shallow neural network 210 may be a first sub-network.

On the basis of primary feature maps, a trained semantic segmentation network 220 is used to extract a semantic feature map. The semantic segmentation network 220 may be implemented using a part of PSPNeT-50. The first view primary feature map F^{l} is input into the semantic segmentation network 220 to obtain a first view semantic feature map Fₛ^{l}, and the second view primary feature map F^{r} is input into the semantic segmentation network 220 to obtain a second view semantic feature map Fₛ^{r}.

To preserve the details of the first view image, for the first view primary feature map F^{l}, another convolution block 230 may be used to calculate a first view transformation feature map Fₜ^{l}. Relative to a size of an original image, sizes of primary feature maps, semantic feature maps, and transformation feature maps are reduced, for example, to ⅛ of the size of the original image. The sizes of the first view primary feature map, the second view primary feature map, the first semantic feature map, the second semantic feature map, and the first view transformation feature map are the same. The sizes of the first view image and the second view image are the same.

A correlation module 240 may be used to calculate matching cost volume between the first view primary feature map F^{l} and the second view primary feature map F^{r}, and obtain a correlation feature map F_{c}. The correlation module 240 may apply a correlation method used in an optical flow prediction network (e.g., FlowNet) to calculate the correlation between two feature maps. A maximum disparity parameter may be set to d in the correlation calculation F^{l}⊙F^{r}. This results the correlation feature map F_{c} with a size of h×w×(d+1), where h refers to a height of the first view primary feature map F^{l}, and w refers to a width of the first view primary feature map F^{l}.

The first view transformation feature map Fₜ^{l}, the first view semantic feature map Fₛ^{l} and the correlation feature map F_{c} are concatenated to obtain a hybrid feature map Fₕ (representing the aforementioned hybrid feature information). The hybrid feature map Fₕ is sent to a subsequent residual network and deconvolution module 250 to obtain a disparity map D with a size the same as the original size of the first view image I^{l}.

The following describes in detail the role of the semantic features provided in this application for the disparity estimation neural network, and a module of applying the semantic features in the disparity estimation neural network.

As mentioned previously, because the difficulty of disparity estimation lies in the local ambiguity problem, local ambiguity mainly comes from one or more relatively blurred, textureless areas in an image. These areas are with unambiguous semantic meaning in segmentation due to continuity inside these areas. Therefore, semantic cues may be used to help predict and rectify a final disparity map. These semantic cues may be incorporated in two ways. In a first aspect, the semantic cues may be embedded into a disparity prediction map in a feature learning procedure. In a second aspect, a training process of the neural network is guided by introducing the semantic cues in calculation of a loss item.

Firstly, the first aspect, how to embed the semantic cues into the disparity prediction map in the feature learning procedure, is introduced.

As mentioned above, referring to FIG. 2, an input stereo image pair includes a first view image and a second view image. A first view primary feature map and a second view primary feature map may be obtained respectively via a shallow neural network 210. Then, a semantic segmentation network 220 may be used to extract semantic features of the first view primary feature map and the second view primary feature map, respectively, so as to obtain a first view semantic feature map and a second view semantic feature map. For the input stereo image pair, the trained shallow neural network 210 and the trained semantic segmentation network 220 (which, for example, may be implemented by a PSP Net-50 framework) are used to extract features, and outputs of final feature mapping of the semantic segmentation network 220 (i.e., conv5_4 feature) are used as the first view semantic feature map Fₛ^{l} and the second view semantic feature map Fₛ^{r}. The shallow neural network 210 may use a part of PSP Net-50, and using outputs of intermediate features of this network (i.e., feature conv3_1) as the first view primary feature map F^{l} and the second view primary feature map F^{r}. To embed a semantic feature, a convolution operation may be performed on the first view semantic feature map Fₛ^{l}. For example, a convolution block of a kernel size 1×1×128 may be used for performing the convolution operation to obtain a converted first semantic feature map F_{s_t}^{l} (not shown in FIG. 2). Then, F_{s_t}^{l} is concatenated with the first view transformation feature map Fₜ^{l} and the correlation feature map F_{c} to obtain the hybrid feature map Fₕ (representing the aforementioned hybrid feature information), and the obtained hybrid feature map Fₕ is sent to the rest of the disparity regression network such as the subsequent residual network and deconvolution module 250.

Then, the second aspect, how to introduce the semantic cues in the calculation of a loss item to train the neural network, is introduced.

When the disparity estimation neural network is trained, the semantic cues are introduced into the loss item, which may help to guide disparity learning. The semantic cues may be represented as a semantic cross-entropy loss L_{seg}. A reconstruction module 260 in FIG. 2 may be used to perform a reconstruction operation on the second view semantic feature map and the disparity prediction map to obtain a reconstructed first semantic feature map, and then ground-truth semantic labels of the first view semantic feature map may be used to measure the semantic cross-entropy loss L_{seg}. A size of the second view semantic feature map Fₛ^{r} is ⅛ of a size of an original image, i.e., the second view image. The disparity prediction map D and the second view image have the same size, that is, are full-sized. To do feature reconstruction, firstly, the second view semantic feature map is up-sampled to a full size, and then the feature reconstruction is applied to the up-sampled full-sized second view semantic feature map as well as the disparity prediction map D, so as to obtain a full-sized reconstructed first view semantic feature map. The full-sized reconstructed first view semantic feature map is down-sampled and rescaled to ⅛ of a full size to obtain the reconstructed first semantic feature map F_{s_w}^{l}. Then, a convolutional classifier with a kernel size 1×1×C is adopted to regularize disparity learning, where C is the number of semantic classes. Finally, the semantic cross-entropy loss L_{seg} is expressed in a form of softmax loss function.

For the training of the disparity estimation neural network in the example, the loss item may include one or more parameters other than the semantic cross-entropy loss. The above semantic information may be cooperated into unsupervised and supervised model training. Methods of calculating a total loss in these two approaches are introduced as follows.

### Unsupervised Approach

An input stereo image pair includes two images, one of which may be reconstructed from the other one using a disparity prediction map. Theoretically, the reconstructed image is similar to the originally input image. Photometric consistency is used to help to learn disparity in an unsupervised approach. Assuming that a disparity prediction image D is given, an image reconstruction operation in a reconstruction module 260 shown in FIG. 2 is applied to a second view image I^{r} to obtain a first view reconstruction image Ĩ^{l}. Then, an L1 norm is used to regularize the photometric consistency. An obtained photometric loss Lₚ is expressed as in formula (1):

$${L}_{p} = \frac{1}{N} {\sum }_{i , j} {‖ {\tilde{I}}_{i , j}^{l} - {I}_{i , j}^{l} ‖}_{1} , \qquad ( 1 )$$

where, N refers to the number of pixels, i and j refer to indexes of the pixels, and ∥ ∥₁ refers to the L1 norm.

The photometric consistency enables the disparity learning in an unsupervised approach. If there is no regularization item in Lₚ to estimate local disparity smoothness, local disparity may be incoherent. To remedy this issue, the L1 norm may be used to penalty or constrain smoothness of a gradient map a ∂D of the disparity prediction map. An obtained smoothness loss Lₛ is expressed as in formula (2):

$${L}_{s} = \frac{1}{n} {\sum }_{i , j} [ {ρ}_{s} ( \partial {D}_{i , j} - \partial {D}_{1 + 1 , j} ) + {ρ}_{s} ( \partial {D}_{i , j} - \partial {D}_{i , j + 1} ) ] , \qquad ( 2 )$$

where, ρₛ(⋅) refers to spatial smoothness penalty function implemented with generalized Charbonnier function.

To use semantic cues, with the semantic feature embedding and semantic loss, at a position of each pixel, there is a predicted value for each possible semantic class. The semantic class may be a road surface, a vehicle, a building, etc. A ground-truth label is used to mark the semantic class, and the ground-truth label may be numbering of a class. The predicted value on the ground-truth label may be largest. The semantic cross-entropy loss L_{seg} is expressed as in formula (3):

$${L}_{seg} = \frac{1}{\vert {N}_{v} \vert} {\sum }_{i ∈ {N}_{v}} {L}_{i} , \qquad ( 3 )$$

where,

$${L}_{i} = - log ( \frac{{e}^{{f}_{yi}}}{{\sum }_{j} {e}^{{f}_{yi}}} ) ,$$

f_{yi} refers to the ground-truth label, yj refers to numbering of a class, f_{yj} refers to an activation value of the class yj, and i refers to the pixel index. The softmax loss of a single pixel is defined as follows: with respect to an entire image, the softmax loss is calculated for a position of each labelled pixel. A set of the labelled pixels refers to Nᵥ.

A total loss Lᵤₙₛᵤₚ in the unsupervised approach may include the photometric loss Lₚ, the smoothness loss Lₛ and the semantic cross-entropy loss L_{seg}. To balance the learning of different loss branches, a loss weight λₚ is introduced for the photometric loss Lₚ, a loss weight λₛ is introduced for the smooth loss Lₛ, and a loss weight λ_{seg} is introduced for the semantic cross-entropy loss L_{seg}. Therefore, the total loss Lᵤₙₛᵤₚ is expressed as in formula (4):

Lᵤₙₛᵤₚ=λₚLₚ+λₛLₛ+λ_{seg}L_{seg} (4).

Then, the disparity prediction neural network is trained based on minimizing the total loss Lᵤₙₛᵤₚ to obtain a preset disparity prediction neural network. A method commonly used by those skilled in the art may be used as a specific training method, which will not be repeated here.

### Supervised Approach

Semantic cues for helping disparity prediction proposed in this application may work well in a supervised approach.

In the supervised approach, for a sample of a stereo image pair, in addition to a first view image and a second view image, a ground-truth disparity image \hat{D} of the stereo image pair is also provided at the same time. Therefore, an L1 norm may be used directly to regularize prediction regression. A disparity regression loss Lᵣ may be expressed in formula (5):

$${L}_{r} = \frac{1}{N} {‖ D - \hat{D} ‖}_{1} . \qquad ( 5 )$$

A total loss Lₛᵤₚ in the supervised approach may include a disparity regression loss Lᵣ, a smoothness loss Lₛ and a semantic cross-entropy loss L_{seg}. To balance the learning of different losses, a loss weight λᵣ is introduced for the disparity regression loss Lᵣ, a loss weight λₛ is introduced for the smoothness loss Lₛ, and a loss weight λ_{seg} is introduced for the semantic cross-entropy loss L_{seg}. Therefore, the total loss Lₛᵤₚ is expressed as in formula (6):

Lₛᵤₚ=λᵣLᵣ+λₛLₛ+λ_{seg}L_{seg} (6).

Then, the disparity prediction neural network is trained based on minimizing the total loss Lₛᵤₚ to obtain a preset disparity prediction neural network. Similarly, a method commonly used by those skilled in the art may be used as a specific training method, which will not be repeated here.

A disparity prediction neural network provided by this application embeds high-level semantic features while extracting correlation information of left and right view images, which helps to improve the prediction accuracy of a disparity map. Moreover, when the neural network is trained, a function for calculating a semantic cross-entropy loss is defined. Rich semantic consistency information may be introduced into the function, which may effectively mitigate common local ambiguity problem. In addition, when an unsupervised learning approach is adopted, since a neural network may be trained according to a photometric difference between a reconstruction image and an original image to output a correct disparity value without providing a large number of ground-truth disparity images, which may effectively reduce training complexity and calculation cost.

It should be noted that main contributions of this technical solution include at least the following parts.

The proposed SegStereo framework cooperates semantic segmentation information into disparity estimation, where semantic consistency can be used as an active guidance for disparity estimation. The semantic feature embedding strategy and semantic loss function, e.g., softmax, can help train the network in an unsupervised or supervised approach. The proposed disparity estimation method can obtain advanced results on both KITTI Stereo 2012 and 2015 benchmark. Prediction on a CityScapes dataset shows the effectiveness of the method. A KITTI Stereo dataset is a computer vision algorithm evaluation dataset for autonomous driving scenes. In addition to data in a raw data format, this dataset provides a benchmark for each task. The CityScapes dataset is a dataset oriented towards semantic understanding of urban street scenes.

FIGS. 3A-3D are diagrams comparing effects of using an existing estimation method with an estimation method provided by the present application on a KITTI Stereo dataset. FIGS. 3A and 3B represent an input stereo image pair. FIG. 3C represents an error map obtained after processing FIGS. 3A and 3B according to the existing prediction method. FIG. 3D represents an error map obtained after processing FIGS. 3A and 3B according to the prediction method provided by the present application. The error map is obtained by subtracting a reconstructed image and an originally input image. Dark areas at the bottom right in FIG. 3C indicate incorrect prediction areas. Compared with FIG. 3C, it can be seen from FIG. 3D that the incorrect areas at the bottom right are greatly reduced. Therefore, under the guidance of semantic cues, the disparity estimation of the SegStereo network is more accurate, especially in a local ambiguous area.

FIGS. 4A and 4B illustrate several qualitative examples on KITTI test sets. According to a method provided by the present application, the SegStereo network can also obtain better disparity estimation results for challenging and complex scenes. FIG. 4A shows qualitative results on KITTI 2012 test data. As shown in FIG. 4A, from left to right: first view images, disparity prediction maps, and error maps. FIG. 4B shows qualitative results on KITTI 2015 test data. As shown in FIG. 4B, from left to right: first view images, disparity prediction maps, and error maps. It can be seen from FIGS. 4A and 4B that there are supervised qualitative results on the KITTI Stereo test sets. By incorporating semantic information, the method proposed in the present application is able to handle complicated scenes.

The SegStereo network can also be adapted to other datasets. For example, the SegStereo network obtained by unsupervised training may be tested on a CityScapes verification set. FIGS. 5A-5C illustrate a prediction result of an unsupervised trained neural network on the CityScapes verification set. FIG. 5A is a first view image. FIG. 5B is a disparity prediction map obtained after processing FIG. 5A using an SGM algorithm. FIG. 5C is a disparity prediction map obtained after processing FIG. 5A using the SegStereo network. Obviously, compared with the SGM algorithm, the SegStereo network produces better results in terms of global scene structure and object details.

In summary, a SegStereo disparity estimation architecture provided by the present application introduces semantic cues into a disparity estimation network. A PSP Net may be used as a segmentation branch to extract semantic features of a stereo image pair. A residual network (ResNet) and a correlation module may be used as a disparity part to regress a disparity prediction map. The correlation module is used to encode matching cues of a stereo image pair. Segmentation features go into a disparity branch behind the correlation module as semantic feature embedding. In addition, semantic consistency of the stereo image pair is reconstructed via semantic loss regularization, which further enhances the robustness of disparity estimation. Both a semantic segmentation network and a disparity regression network are fully convolutional, so that the networks can be trained end-to-end.

Incorporating semantic cues into the SegStereo network can be used for unsupervised and supervised training. In the unsupervised training procedure, both a photometric consistency loss and a semantic cross-entropy loss are computed and propagated backward. Beneficial constraints of semantic consistency may be introduced into both the semantic feature embedding and semantic cross-entropy loss. In addition, for the supervised training scheme, the supervised disparity regression loss may be used instead of the unsupervised photometric consistency loss to train a neural network, which will obtain advanced results on a KITTI Stereo benchmark, such as KITTI Stereo 2012 and 2015 benchmarks. The prediction on the CityScapes dataset shows the effectiveness of this method.

According to the method of estimating disparity of a stereo image pair in conjunction with semantic information, a first view image and a second view image of a target scene are firstly obtained. Primary feature maps of the first view image and the second view image are extracted using a feature extraction network. For a first view primary feature map, a convolution block is used to obtain a first view transformation feature map. On the basis of the first view primary feature map and a second view primary feature map, a correlation module is used to calculate a correlation feature map between the first view primary feature map and the second view primary feature map. Then, a semantic segmentation network is used to obtain a first view semantic feature map. The first view transformation feature map, the correlation feature map, and the first view semantic feature map are concatenated to obtain a hybrid feature map. Finally, a residual network and a deconvolution module are used to regress a disparity prediction map. In this way, the first view image and the second view image are input to a disparity estimation neural network including the feature extraction network, the semantic segmentation network, and a disparity regression network, and the disparity prediction map can be quickly output, thereby achieving end-to-end disparity prediction and meeting real-time requirements. When matching features between the first view image and the second view image are calculated, the semantic feature map is embedded, that is, a semantic consistency constraint is imposed, which decreases the local ambiguity problem to a certain extent, and improves the accuracy of disparity prediction.

It should be understood that various specific implementations in the examples shown in FIG. 1 to FIG. 2 may be combined in any manner according to logic thereof, and are not necessarily to be met at the same time, that is, any one or more of the steps and/or procedures in a method example shown in FIG. 1 may use an example shown in FIG. 2 as an optional specific implementation, but not limited thereto.

It should also be understood that the examples shown in FIGS. 1 to 2 are only exemplary embodiments of the present application. Those skilled in the art may make various obvious changes and/or replacements based on the examples in FIGS. 1 to 2, and technical solutions obtained therefrom still belong to the scope disclosed in the examples of the present application.

Corresponding to the image disparity estimation method, examples of the present disclosure provide an image disparity estimation apparatus. As shown in FIG. 6, the apparatus includes the following modules.

An image obtaining module 10 is configured to obtain a first view image and a second view image of a target scene.

A disparity estimation neural network 20 is configured to obtain disparity prediction information based on the first view image and the second view image. The disparity estimation neural network 20 includes the following modules.

A primary feature extraction module 21 is configured to perform feature extraction processing on the first view image to obtain first view feature information.

A semantic feature extraction module 22 is configured to perform semantic segmentation processing on the first view image to obtain first view semantic segmentation information.

A disparity regression module 23 is configured to obtain disparity prediction information between the first view image and the second view image based on the first view feature information, the first view semantic segmentation information, and correlation information between the first view image and the second view image.

In the above solution, optionally, the primary feature extraction module 21 is further configured to perform the feature extraction processing on the second view image to obtain second view feature information. The disparity regression module 23 further includes: a correlation feature extraction module configured to perform correlation processing based on the first view feature information and the second view feature information to obtain the correlation information.

As an implementation, optionally, the disparity regression module 23 is further configured to: perform hybrid processing on the first view feature information, the first view semantic segmentation information, and the correlation information to obtain hybrid feature information; and obtain the disparity prediction information based on the hybrid feature information.

In the above solutions, optionally, the apparatus further includes: a first network training module 24 configured to train the disparity estimation neural network 20 based on the disparity prediction information.

As an implementation, optionally, the first network training module 24 is further configured to: perform the semantic segmentation processing on the second view image to obtain second view semantic segmentation information; obtain first view reconstruction semantic information based on the second view semantic segmentation information and the disparity prediction information; and adjust network parameters of the disparity estimation neural network 20 based on the first view reconstruction semantic information.

As an implementation, optionally, the first network training module 24 is further configured to: determine a semantic loss value based on the first view reconstruction semantic information; and adjust the network parameters of the disparity estimation neural network 20 based on the semantic loss value.

As an implementation, optionally, the first network training module 24 is further configured to: adjust the network parameters of the disparity estimation neural network 20 based on the first view reconstruction semantic information and a first semantic label of the first view image; or adjust the network parameters of the disparity estimation neural network 20 based on the first view reconstruction semantic information and the first view semantic segmentation information.

As an implementation, optionally, the first network training module 24 is further configured to: obtain a first view reconstruction image based on the disparity prediction information and the second view image; determine a photometric loss value based on a photometric difference between the first view reconstruction image and the first view image; determine a smoothness loss value based on the disparity prediction information; and adjust the network parameters of the disparity estimation neural network 20 based on the photometric loss value and the smoothness loss value.

In the above solutions, optionally, the apparatus further includes: a second network training module 25 configured to train the disparity estimation neural network 20 based on the disparity prediction information and labelled disparity information, where the first view image and the second view image correspond to the labelled disparity information.

As an implementation, optionally, the second network training module 25 is further configured to: determine a disparity regression loss value based on the disparity prediction information and the labelled disparity information; and adjust network parameters of the disparity estimation neural network based on the disparity regression loss value.

It should be understood by those skilled in the art that functions realized by the processing modules in the image disparity estimation apparatus shown in FIG. 6 may be understood with reference to the relevant description of the foregoing image disparity estimation methods. It should be understood by those skilled in the art that functions of the processing units in the image disparity estimation apparatus shown in FIG. 6 may be realized by programs running on a processor, or by a specific logic circuit.

In practice, the image obtaining module 10 has a different structure depending on how the module obtains the information. When receiving from a client, the image obtaining module 10 can be a communication interface. When automatically collecting, the image obtaining module 10 corresponds to an image collector. The specific structures of the image obtaining module 10 and the disparity estimation neural network 20 may correspond to one or more processors. The specific structure of a processor may be a CPU (Central Processing Unit), an MCU (Micro Controller Unit), a DSP (Digital Signal Processor), a PLC (Programmable Logic Controller) or other electronic components with processing functions or a set of electronic components. The processor may run executable codes. The executable codes are stored in a storage medium. The processor may be connected to the storage medium through a communication interface such as a bus. When performing corresponding functions of specific modules, the executable codes are read from the storage medium and running. A part of the storage medium for storing the executable codes is a non-volatile storage medium.

The image obtaining module 10 and the disparity estimation neural network 20 may be integrated and correspond to the same processor, or respectively correspond to different processors. When the image obtaining module 10 and the disparity estimation neural network 20 are integrated and correspond to the same processor, the processor uses time division to process corresponding functions of the image obtaining module 10 and the disparity estimation neural network 20.

With the image disparity estimation apparatus provided by the examples of the present application, the disparity estimation neural network including the primary feature extraction module, the semantic feature extraction module, and the disparity regression module is adopted, the input is the first and second view images, and a disparity prediction map can be output quickly, thereby achieving end-to-end disparity prediction and meeting real-time requirements. When features of the first view image and the second view image are calculated, the semantic feature map is embedded, that is, a semantic consistency constraint is imposed, which decreases the local ambiguity problem to a certain extent, and improves the accuracy of disparity prediction as well as the precision of final disparity prediction.

Examples of the present application further provides an image disparity estimation apparatus. The image disparity estimation apparatus includes: a memory, a processor and a computer-readable program stored in the memory and executable by the processor, when the computer-readable program is executed by the processor, the processor implements an image disparity estimation method according to any of the technical solutions described above.

As an implementation, the processor executes the computer-readable program to: perform the feature extraction processing on the second view image to obtain second view feature information; and perform correlation processing based on the first view feature information and the second view feature information to obtain the correlation information.

As an implementation, the processor executes the computer-readable program to: perform hybrid processing on the first view feature information, the first view semantic segmentation information, and the correlation information to obtain hybrid feature information; and obtain the disparity prediction information based on the hybrid feature information.

As an implementation, the processor executes the computer-readable program to: train a disparity estimation neural network based on the disparity prediction information.

As an implementation, the processor executes the computer-readable program to: perform the semantic segmentation processing on the second view image to obtain second view semantic segmentation information; obtain first view reconstruction semantic information based on the second view semantic segmentation information and the disparity prediction information; and adjust network parameters of the disparity estimation neural network based on the first view reconstruction semantic information.

As an implementation, the processor executes the computer-readable program to: determine a semantic loss value based on the first view reconstruction semantic information; and adjust the network parameters of the disparity estimation neural network based on the semantic loss value.

As an implementation, the processor executes the computer-readable program to: adjust the network parameters of the disparity estimation neural network based on the first view reconstruction semantic information and a first semantic label of the first view image; or adjust the network parameters of the disparity estimation neural network based on the first view reconstruction semantic information and the first view semantic segmentation information.

As an implementation, the processor executes the computer-readable program to: obtain a first view reconstruction image based on the disparity prediction information and the second view image; determine a photometric loss value based on a photometric difference between the first view reconstruction image and the first view image; determine a smoothness loss value based on the disparity prediction information; and adjust the network parameters of the disparity estimation neural network based on the photometric loss value and the smoothness loss value.

As an implementation, the processor executes the computer-readable program to: train a disparity estimation neural network for implementing the method based on the disparity prediction information and labelled disparity information, where the first view image and the second view image correspond to the labelled disparity information.

As an implementation, the processor executes the computer-readable program to: determine a disparity regression loss value based on the disparity prediction information and the labelled disparity information; and adjust network parameters of the disparity estimation neural network based on the disparity regression loss value.

The image disparity estimation apparatus provided by the examples of the present application can improve the accuracy of disparity prediction and the precision of final disparity prediction.

Examples of the present application further describe a computer storage medium that stores computer executable instructions, when the computer executable instructions are used to execute the image disparity estimation method described in the above examples. That is to say, after the computer executable instructions are executed by the processor, the image disparity estimation method according to any one of the technical solutions as described above may be implemented.

It should be understood by those skilled in the art that functions of the programs in the computer storage medium according to the example may be understood with reference to the relevant description of the image disparity estimation method described in the above examples.

Based on the image disparity estimation method and apparatuses described in the above examples, specific application scenes in the field of unmanned driving is given below.

A disparity estimation neural network is applied to an unmanned driving platform, so as to output a disparity map in front of a vehicle in real-time when facing a road traffic scene, which further allows estimating a distance of each target and position ahead. For more complex cases, such as a large target, occlusion, etc., the disparity estimation neural network may also effectively provide reliable disparity prediction. On an automatous driving platform installed with a binocular stereo camera, the disparity estimation neural network may give an accurate disparity prediction result when facing a road traffic scene, especially for a local ambiguity position (e.g., a bright light, a mirror surface, a large target). In this way, smart vehicles may obtain clearer information about surroundings and road conditions, and perform unmanned driving based on the information about surroundings and road conditions, thereby improving driving safety.

In several examples provided by this application, it should be understood that the disclosed apparatuses and methods may be implemented in other ways. The apparatus examples described above are only schematic. For example, the division of units is merely a logical function division, and in actual implementation, there may be another division manner. For example, multiple units or components may be combined, or integrated into another system, or some features may be ignored, or not be implemented. In addition, the coupling or direct coupling or communication connection between displayed or discussed components may be through some interfaces, and indirect coupling or communication connection between apparatuses or units, which may be electrical, mechanical or in other forms.

The units described as separate components may or may not be physically separated, and the components displayed as units may or may not be physical units, which may be located in one place or may be distributed to multiple network units. Some or all of the units may be selected according to actual needs to achieve the objectives of the present application.

In addition, all functional units in the examples of the present application may be integrated into one processing unit, or each unit may be individually used as one unit, or two or more units may be integrated into one unit. The integrated unit may be implemented in the form of hardware, or in the form of hardware and software functional units.

It should be understood by those skilled in the art that all or part of the steps to implement the method examples may be accomplished by hardware associated with program instructions. The program may be stored in a computer readable storage medium. The computer-readable program is executed to perform steps included in the method examples. The storage medium includes: a movable storage device, a ROM (Read-Only Memory), a RAM (Random Access Memory), a magnetic disk, a compact disk, or other medium that can store program codes.

Alternatively, the integrated unit in the present application may be stored in a computer readable storage medium if implemented as a software function module and sold or used as a standalone product. Based on this understanding, the technical solutions in the examples of the present application, which essentially or in part contribute to the prior art, may be embodied in the form of a software product. The computer software product is stored in a storage medium and includes several instructions to cause a computer device, which may be a personal computer, a server, a network device, etc., to execute all or part of the methods described in the examples of the present application. The storage medium includes: a movable storage device, a ROM, a RAM, a magnetic disk, a compact disk, or other medium that can store program codes.

What is claimed is:

1. An image disparity estimation method, comprising:
obtaining a first view image and a second view image of a target scene;
performing feature extraction processing on the first view image to obtain first view feature information;
performing semantic segmentation processing on the first view image to obtain first view semantic segmentation information; and
obtaining disparity prediction information between the first view image and the second view image based on the first view feature information, the first view semantic segmentation information, and correlation information between the first view image and the second view image.

2. The method according to claim 1, further comprising:
performing the feature extraction processing on the second view image to obtain second view feature information; and
performing correlation processing based on the first view feature information and the second view feature information to obtain the correlation information.

3. The method according to claim 1, wherein obtaining the disparity prediction information between the first view image and the second view image based on the first view feature information, the first view semantic segmentation information, and the correlation information between the first view image and the second view image comprises:
performing hybrid processing on the first view feature information, the first view semantic segmentation information, and the correlation information to obtain hybrid feature information; and
obtaining the disparity prediction information based on the hybrid feature information.

4. The method according to claim 1, wherein the image disparity estimation method is implemented by a disparity estimation neural network, and the method further comprises:
training the disparity estimation neural network based on the disparity prediction information.

5. The method according to claim 4, wherein training the disparity estimation neural network based on the disparity prediction information comprises:
performing the semantic segmentation processing on the second view image to obtain second view semantic segmentation information;
obtaining first view reconstruction semantic information based on the second view semantic segmentation information and the disparity prediction information; and
adjusting network parameters of the disparity estimation neural network based on the first view reconstruction semantic information.

6. The method according to claim 5, wherein adjusting the network parameters of the disparity estimation neural network based on the first view reconstruction semantic information comprises:
determining a semantic loss value based on the first view reconstruction semantic information; and
adjusting the network parameters of the disparity estimation neural network based on the semantic loss value.

7. The method according to claim 5, wherein adjusting the network parameters of the disparity estimation neural network based on the first view reconstruction semantic information comprises:
adjusting the network parameters of the disparity estimation neural network based on the first view reconstruction semantic information and a first semantic label of the first view image; or
adjusting the network parameters of the disparity estimation neural network based on the first view reconstruction semantic information and the first view semantic segmentation information.

8. The method according to claim 4, wherein training the disparity estimation neural network based on the disparity prediction information comprises:
obtaining a first view reconstruction image based on the disparity prediction information and the second view image;
determining a photometric loss value based on a photometric difference between the first view reconstruction image and the first view image;
determining a smoothness loss value based on the disparity prediction information; and
adjusting the network parameters of the disparity estimation neural network based on the photometric loss value and the smoothness loss value.

9. The method according to claim 1, wherein the first view image and the second view image correspond to labelled disparity information, and the method further comprises:
training a disparity estimation neural network for implementing the method based on the disparity prediction information and the labelled disparity information.

10. The method according to claim 9, wherein training the disparity estimation neural network based on the disparity prediction information and the labelled disparity information comprises:
determining a disparity regression loss value based on the disparity prediction information and the labelled disparity information; and
adjusting network parameters of the disparity estimation neural network based on the disparity regression loss value.

11. An image disparity estimation apparatus, comprising:
a processor, and
a memory storing a computer-readable program executable by the processor,
wherein the processor is configured to:
obtain a first view image and a second view image of a target scene;
perform feature extraction processing on the first view image to obtain first view feature information;
perform semantic segmentation processing on the first view image to obtain first view semantic segmentation information; and
obtain disparity prediction information between the first view image and the second view image based on the first view feature information, the first view semantic segmentation information, and correlation information between the first view image and the second view image.

12. The apparatus according to claim 11, the processor is further configured to:
perform the feature extraction processing on the second view image to obtain second view feature information; and
perform correlation processing based on the first view feature information and the second view feature information to obtain the correlation information.

13. The apparatus according to claim 11, wherein the processor is further configured to obtain the disparity prediction information by:
performing hybrid processing on the first view feature information, the first view semantic segmentation information, and the correlation information to obtain hybrid feature information; and
obtaining the disparity prediction information based on the hybrid feature information.

14. The apparatus according to claim 11, wherein the image disparity estimation apparatus is implemented by a disparity estimation neural network, and the processor is further configured to:
train the disparity estimation neural network based on the disparity prediction information.

15. The apparatus according to claim 14, wherein the processor is further configured to train the disparity estimation neural network by:
performing the semantic segmentation processing on the second view image to obtain second view semantic segmentation information;
obtaining first view reconstruction semantic information based on the second view semantic segmentation information and the disparity prediction information; and
adjusting network parameters of the disparity estimation neural network based on the first view reconstruction semantic information.

16. The apparatus according to claim 15, wherein the processor is further configured to adjust the network parameters of the disparity estimation neural network by:
determining a semantic loss value based on the first view reconstruction semantic information; and
adjusting the network parameters of the disparity estimation neural network based on the semantic loss value.

17. The apparatus according to claim 15, wherein the processor is further configured to adjust the network parameters of the disparity estimation neural network by:
adjusting the network parameters of the disparity estimation neural network based on the first view reconstruction semantic information and a first semantic label of the first view image; or
adjusting the network parameters of the disparity estimation neural network based on the first view reconstruction semantic information and the first view semantic segmentation information.

18. The apparatus according to claim 14, wherein the processor is further configured to train the disparity estimation neural network by:
obtaining a first view reconstruction image based on the disparity prediction information and the second view image;
determining a photometric loss value based on a photometric difference between the first view reconstruction image and the first view image;
determining a smoothness loss value based on the disparity prediction information; and
adjusting the network parameters of the disparity estimation neural network based on the photometric loss value and the smoothness loss value.

19. The apparatus according to claim 11, wherein the first view image and the second view image correspond to labelled disparity information, and the processor is further configured to:
train a disparity estimation neural network for implementing the apparatus based on the disparity prediction information and the labelled disparity information by:
determining a disparity regression loss value based on the disparity prediction information and the labelled disparity information; and
adjusting network parameters of the disparity estimation neural network based on the disparity regression loss value.

20. A non-transitory computer-readable storage medium storing a computer-readable program that, when the computer-readable program is executed by a processor, causes the processor to:
obtain a first view image and a second view image of a target scene;
perform feature extraction processing on the first view image to obtain first view feature information;
perform semantic segmentation processing on the first view image to obtain first view semantic segmentation information; and
obtain disparity prediction information between the first view image and the second view image based on the first view feature information, the first view semantic segmentation information, and correlation information between the first view image and the second view image.
